(19) United States
(12) Patent Application Publication
(10) Pub. No.: US 2026/0185854 A1
(43) Pub. Date: Jul. 2, 2026

(54) QUANTUM SENSOR AND METHOD FOR FABRICATING THE SAME

(71) Applicant: ELECTRONICS AND TELECOMMUNICATIONS RESEARCH INSTITUTE, Daejeon (KR)

(72) Inventors: Jong Sung MOON, Daejeon (KR); Young-Ho KO, Daejeon (KR)

(21) Appl. No.: 19/389,916

(22) Filed: Nov. 14, 2025

(30) Foreign Application Priority Data
Dec. 27, 2024 (KR) 10-2024-0198200
Apr. 24, 2025 (KR) 10-2025-0053850

(51) Int. Cl. G01D 5/34

(52) U.S. Cl. CPC G01D 5/34

(57) ABSTRACT

A quantum sensor includes a substrate, an optical resonator disposed on the substrate and including nanoholes arranged in a circular Bragg grating structure, a control structure disposed on the substrate and arranged adjacent to the optical resonator, a connection structure disposed on the substrate and electrically connected to the control structure, and a connector which is electrically connected to the connection structure and transmits microwaves to the optical resonator. The optical resonator includes point defects.

### CROSS-REFERENCE TO RELATED APPLICATIONS

This U.S. non-provisional patent application claims priority under 35 U.S.C. § 119 of Korean Patent Application Nos. 10-2024-0198200, filed on December 27, 2024, and 10-2025-0053850, filed on April 24, 2025, the entire contents of which are hereby incorporated by reference.

### BACKGROUND

### 1. Field of the Invention

The present disclosure herein relates to a quantum sensor, and more particularly, to a quantum sensor having a flexible structure.

### 2. Description of Related Art

Point defects in a solid refer to atomic defects in a solid crystal in which atoms in specific positions are missing or replaced by other atoms in an arrangement of chemically bonded atoms in a solid state. These point defects may create a new defect-induced quantum energy state in a bandgap in the solid crystal and be utilized as spin qubits using quantum spin numbers or quantum light sources through optical transitions in defect energy states.

In particular, the point defects are recently receiving attention as spin qubits for potential application to a quantum sensing technology, and this is because among various quantum technologies such as quantum computing and quantum communication, quantum sensing is the lowest in difficulty level of implementation and is the highest in possibility of practical application in the near future.

The quantum sensing means a technology which utilizes properties of quantum mechanics, such as quantum energy state, quantum superposition or quantum entanglement, and measures various physical parameters (magnetic field, temperature, stress, gravity, etc.), and quantum platforms capable of implementing the quantum sensing include very various types such as atom, super-conducting, and optical interferometer.

Among the types, in the case of point defects in a solid, an optical type enables control and readout of the spin qubits and is thus convenient as well as has the biggest merit in fabrication of a practical device with versatility and multifunctionality. Therefore, fabrication of practical quantum sensors utilizing the point defects is one of necessary research ways forward.

### SUMMARY

The present disclosure provides a quantum sensor provided on a flexible substrate, and a method for fabricating the quantum sensor.

The present disclosure also provides a quantum sensor attachable to and detachable from various structures, and a method for fabricating the quantum sensor.

An embodiment of the inventive concept provides a quantum sensor including a substrate, an optical resonator disposed on the substrate and including nanoholes arranged in a circular Bragg grating structure, a control structure disposed on the substrate and arranged adjacent to the optical resonator, a connection structure disposed on the substrate and electrically connected to the control structure, and a connector which is electrically connected to the connection structure and transmits microwaves to the optical resonator. The optical resonator may include point defects.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view of a quantum sensor according to an embodiment of the inventive concept;

FIG. 2 is an exploded view of the quantum sensor in FIG. 1;

FIG. 3 is a cross-sectional view taken along line A-A' in FIG. 1;

FIG. 4 is a flowchart illustrating a measurement method using a quantum sensor according to an embodiment of the inventive concept;

FIG. 5 is a graph illustrating a result of readout of a magnetic field according to an embodiment of the inventive concept; and

FIG. 6 is a graph illustrating a result of readout of a temperature according to an embodiment of the inventive concept.

### DETAILED DESCRIPTION

Hereinafter, embodiments of the inventive concept are described with reference to the accompanying drawings to describe the inventive concept in detail.

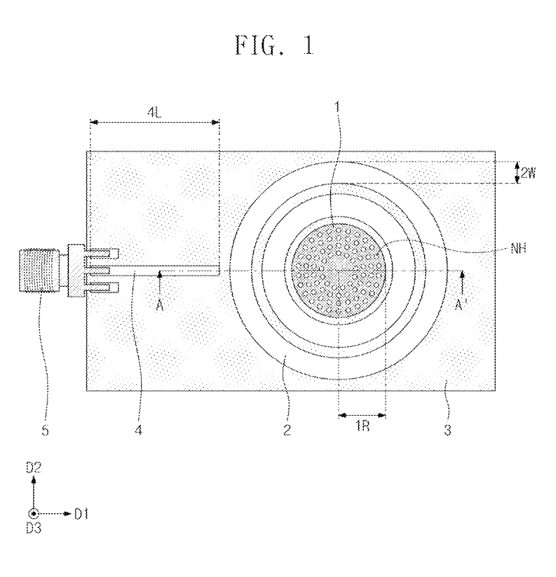

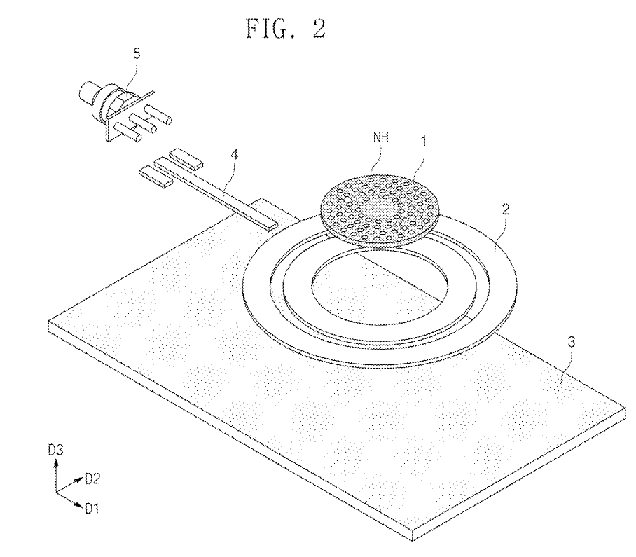

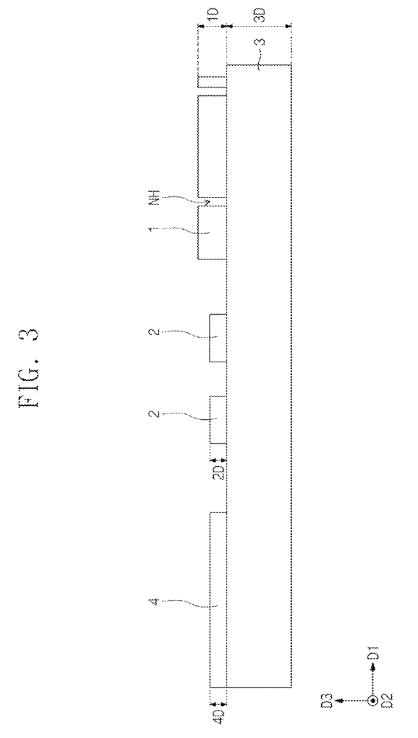

FIG. 1 is a plan view of a quantum sensor according to an embodiment of the inventive concept. FIG. 2 is an exploded view of the quantum sensor in FIG. 1. FIG. 3 is a cross-sectional view taken along line A-A' in FIG. 1.

Referring to FIGS. 1 to 3, a substrate 3 may be provided. The substrate 3 may be a flexible substrate. The substrate 3 may include a polymer, and may include at least one of polydimethylsiloxane, polyimide, polyethylene terephthalate, polycarbonate, polymethyl methacrylate, polyurethane, or polyethylene naphthalate. A thickness 3D of the substrate 3 in a third direction D3 may be, for example, about 0.1 mm to about 1 mm.

As used herein, a first direction D1 may be a direction parallel to a top surface of the substrate 3. A second direction D2 may be a direction parallel to the top surface of the substrate 3 and crossing the first direction D1. The third direction D3 may be a direction perpendicular to the top surface of the substrate 3.

An optical resonator 1 may be disposed on the substrate 3. The optical resonator 1 may include a quantum material including point defects. The optical resonator 1 may have a spin resonance frequency of about 2 GHz to about 6 GHz.

The optical resonator 1 may have a circular shape in a plan view. The optical resonator 1 may include nanoholes NH arranged in a circular Bragg grating structure. In more detail, the nanoholes NH may be spaced apart from each other radially from a center of the optical resonator. The nanoholes NH may be spaced apart from each other along a circumferential direction of the optical resonator 1.

The top surface of the substrate 3 may be exposed by the nanoholes NH. The nanoholes NH may be arranged in the circular Bragg grating structure, thereby improving a light extraction effect of the optical resonator and enabling rapid spontaneous emission. Moreover, as the nanoholes NH are arranged in the circular Bragg grating structure, the optical resonator may have a narrow emission angle, thereby easily enabling light trapping.

The optical resonator 1 may include a two-dimensional material. The optical resonator 1 may be in the form of a thin film including the two-dimensional material. The two-dimensional material may have a structure in which an atomic layer is soft and flexible. Thus, the optical resonator 1 may be bent to fit the movement of the substrate 3 and may be thus applied onto the flexible substrate 3. Furthermore, the two-dimensional material may sensitively respond to physical movements of, for example, a magnetometer, a thermometer, a stress sensor, and a pressure gauge. Furthermore, the two-dimensional material may constitute the optical resonator in the form of a thin film and may be thus easily deposited on the substrate 3, thereby improving a difficulty level of a process of fabricating the quantum sensor.

For example, the two-dimensional material may include one of hexagonal boron nitride (hBN), silicon carbide, and diamond. The two-dimensional material may be preferably hexagonal boron nitride, and in this case, the point defects may be boron vacancies.

A thickness 1D of the optical resonator 1 in the third direction D3 may be about 100 nm to about 250 nm. A diameter 1R of the optical resonator 1 may be, for example, about 5 μm to about 10 μm.

A connector 5 may be disposed on the substrate 3. The connector 5 may include, for example, a coaxial cable and may include, for example, a BNC or SMA cable. The connector 5 may be disposed on one end of the substrate 3. The connector 5 may be spaced apart from the optical resonator 1 in the first direction D1. The connector 5 may transmit microwaves to the optical resonator 1 from an external device.

A connection structure 4 may be disposed on the substrate 3 and may be electrically connected to the connector 5. The connection structure 4 may be arranged adjacent to the connector 5 and may be disposed on the one end of the substrate 3. The connection structure 4 may be in contact with the connector 5. The connection structure 4 may have, for example, a bar shape extending from the connector 5 toward the optical resonator 1. However, an embodiment of the inventive concept may not be limited thereto, and the connection structure 4 may have various shapes. The connection structure 4 may be a flexible electrode. The connection structure 4 may be, for example, a thin metal thin-film. The connection structure 4 may include at least one selected from the group consisting of gold (Au), titanium (Ti), chrome (Cr), platinum (Pt), silver (Ag), and alloys thereof. A width 4L of the connection structure 4 in the first direction D1 may be, for example, about 3 mm to about 20 mm, and a thickness 4D of the connection structure 4 in the third direction D3 may be, for example, about 50 nm to about 100 nm.

A control structure 2 may be disposed on the substrate 3 and may be arranged adjacent to the optical resonator 1. The control structure 2 may be interposed between the optical resonator 1 and the connection structure 4. The control structure 2 may be electrically connected to the connector 5, and emit microwaves to the optical resonator 1 and control the optical resonator 1. The control structure 2 may be electrically connected to the connector 5 through the connection structure 4. Accordingly, the control structure 2 may irradiate the optical resonator 1 with the microwaves transmitted from the connector 5.

In more detail, the control structure 2 may irradiate the optical resonator 1 with the microwaves corresponding to the spin resonance frequency of the optical resonator 1. Accordingly, the control structure 2 may control spin qubits of the quantum material of the optical resonator 1 to a state of 0, 1, or a quantum superposition of 0 and 1.

The control structure 2 may have a ring shape in a plan view. The control structure 2 may have a structure in which a plurality of rings surround the optical resonator 1. However, an embodiment of the inventive concept is not limited thereto, and the control structure 2 may have various shapes. For example, the control structure 2 may include a linear wire or omega (Ω) shape.

The control structure 2 may be a flexible electrode. The control structure 2 may be a flexible electrode which may be bent or curved according to the movement of the substrate 3. The control structure 2 may be, for example, a thin metal thin-film. The control structure 2 may include at least one selected from the group consisting of gold (Au), titanium (Ti), chrome (Cr), platinum (Pt), silver (Ag), and alloys thereof. A width 2W of the control structure 2 in the second direction D2 may be, for example, about 1 mm to about 2 mm, and a thickness 2D of the control structure 2 in the third direction D3 may be, for example, about 50 nm to about 100 nm.

In the quantum sensor according to an embodiment of the inventive concept, the optical resonator 1 may be provided on the flexible substrate 3. The optical resonator 1 may include the two-dimensional material and be thus bent to fit the movement of the flexible substrate 3. Thus, the quantum sensor according to the inventive concept may be easily attachable to and detachable from various body parts and various structures.

Referring to FIGS. 1 to 3 again, a method for fabricating a quantum sensor according to an embodiment of the inventive concept is described. With regard to the quantum sensor described with reference to FIGS. 1 to 3, overlapping contents will be omitted for simplification of the description.

Referring to FIGS. 1 to 3, a substrate 3 may be formed. The forming of the substrate 3 may include, for example, spin coating a polymer and curing the polymer.

A connection structure 4 may be formed on the substrate. The connection structure 4 may be formed on one end of the substrate 3. The forming of the connection structure 4 may include, for example, patterning and depositing a metal thin film on the substrate 3.

A control structure 2 may be formed on the substrate 3. The forming of the control structure 2 may include, for example, patterning and depositing a metal thin film on the substrate 3.

An optical resonator 1 may be formed on the substrate 3 and may be formed adjacent to the control structure 2. The optical resonator 1 may be spaced apart from the connection structure 4 with the control structure 2 interposed therebetween. The optical resonator 1 may include a low-dimensional material and may include, for example, a two-dimensional material. The optical resonator 1 may be in the form of a circular thin film and may include nanoholes NH having a circular Bragg grating structure. The nanoholes NH may be spaced apart from each other along a circumferential direction of the optical resonator 1, and may be radially spaced apart from each other.

The forming of the optical resonator 1 may include, for example, at least one of drop casting or transfer printing technique.

According to embodiments of the inventive concept, the optical resonator 1 may include a two-dimensional material. The two-dimensional material may constitute the optical resonator in the form of a thin film and may be thus easily deposited on the substrate 3, thereby improving a difficulty level of a process of fabricating the quantum sensor.

A connector 5 may be formed on the substrate 3. The connector 5 may be in contact with the connection structure 4. The forming of the connector 5 may include, for example, one of soldering and wire bonding.

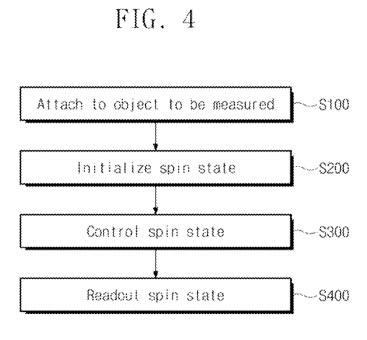

FIG. 4 is a flowchart illustrating a measurement method using a quantum sensor according to an embodiment of the inventive concept. With regard to the quantum sensor described with reference to FIGS. 1 to 3, overlapping contents will be omitted for simplification of the description.

Referring to FIG. 4, the quantum sensor may be operated by an optically detected magnetic resonance method. The quantum sensor may be allowed to approach an object to be measured (S100).

In the quantum sensor according to an embodiment of the inventive concept, an optical resonator 1 may be provided on a flexible substrate 3. The optical resonator 1 may include a two-dimensional material and be thus bent to fit the movement of the flexible substrate 3. Thus, the quantum sensor according to the inventive concept may be easily attachable to and detachable from various body parts and various structures.

Thereafter, a spin state of the optical resonator 1 may be initialized (S200). In more detail, a spin state of point defects in the optical resonator 1 may be initialized. The spin state of the optical resonator 1 may be initialized by photoexcitation through an external device. In more details, a spin qubit of a quantum material of the optical resonator may become 0.

Thereafter, the spin state of the optical resonator 1 may be controlled (S300). In more detail, the spin state of the point defects in the optical resonator 1 may be controlled. The spin state of the optical resonator 1 may be controlled through a connector 5, a connection structure 4, and a control structure 2. In more detail, the spin state of the optical resonator may be controlled by irradiating the optical resonator 1 with microwaves corresponding to a spin resonance frequency of the optical resonator 1.

Thereafter, readout of optical emittance of the optical resonator 1 may be performed (S400). In more detail, a laser may be emitted to the optical resonator 1 through an external device and thus excite the optical resonator 1. Thereafter, the readout of the optical emittance of the optical resonator 1 may be conducted. Properties of the object to be measured may be measured by readout of a change in the optical emittance.

Hereinafter, the inventive concept will be described with reference to embodiments of the inventive concept.

### Embodiment

A substrate was formed by spin coating polydimethylsiloxane on a silicon structure. A thickness of the substrate in the third direction was about 1 mm. A connection structure and a control structure were formed on the substrate. A width of the connection structure in the second direction was about 1 mm, and a thickness of the connection structure in the third direction was about 100 nm. The control structure was formed in a double split-ring structure. A width of each of double split-rings in the first direction was about 2 mm, and a thickness of the double split-ring in the third direction was about 100 nm. Each of the connection structure and the control structure was formed by using gold (Au).

Thereafter, an optical resonator was formed. In the optical resonator, a hexagonal boron nitride (hBN) thin film in which nanoholes having a circular Bragg grating structure are arranged was formed by a transfer printing method. A thickness of the optical resonator in the third direction was about 200 nm, and a diameter of the optical resonator was about 10 μm. Thereafter, a SMA connector was formed on the substrate through soldering.

### Evaluation Example 1: Magnetic Field Sensing

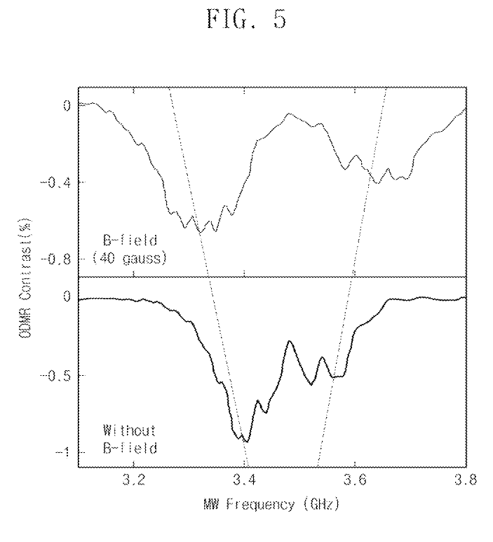

Magnetic field sensing was evaluated by applying a static magnetic field from the outside. Referring to FIG. 5, a Zeeman effect due to the magnetic field was detected in an optically detected magnetic resonance method.

### Evaluation Example 2: Temperature Sensing

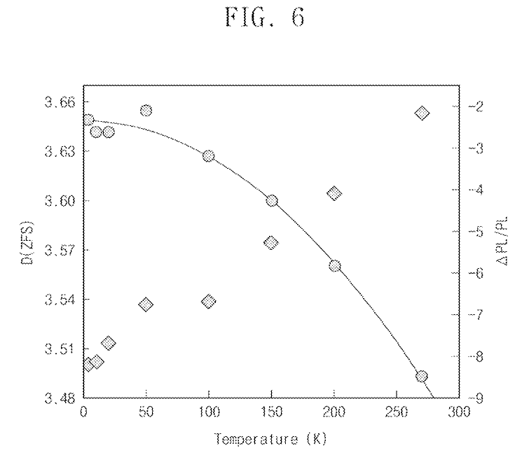

A temperature measurement capability was tested by mounting a quantum sensor according to an embodiment in a refrigerating machine capable of cooling up to a temperature of about 4 K. Referring to FIG. 6, it was confirmed that it is possible to measure a temperature through spin state changes and optical variations of the optical resonator over temperature.

The quantum sensor according to the embodiment of the inventive concept may include the quantum material including the point defects. The quantum material may include the low-dimensional material (e.g., two-dimensional material). The low-dimensional material may have the structure in which the atomic layer is soft and flexible, and be applied onto the flexible substrate. Therefore, the quantum sensor applied onto the flexible substrate may be provided.

Furthermore, the quantum material according to the inventive concept may include the nanoholes arranged in the circular Bragg grating structure. This structure may enable the high light extraction effect and the rapid spontaneous emission of the quantum sensor.

In the above, the embodiments of the inventive concept have been described with reference to the accompanying drawings, but those skilled or of ordinary skill in the art to which the present invention belongs may understand that various modifications and changes may be made to the inventive concept insofar as such modifications and changes do not depart from the spirit and technical scope of the inventive concept set forth in the claims to be described later. It will be further understood that the embodiment set forth herein is not to limit the technical spirit of the inventive concept, and all the technical spirit set forth in the claims and the like should be interpreted to be embraced in the scope of the right of the present invention.

What is claimed is:

1. A quantum sensor comprising:
a substrate;
an optical resonator disposed on the substrate and comprising nanoholes arranged in a circular Bragg grating structure;
a control structure disposed on the substrate and arranged adjacent to the optical resonator;
a connection structure disposed on the substrate and electrically connected to the control structure; and
a connector electrically connected to the connection structure and configured to transmit microwaves to the optical resonator,
wherein the optical resonator comprises point defects.

2. The quantum sensor of claim 1, wherein the substrate comprises a polymer.

3. The quantum sensor of claim 1, wherein the optical resonator comprises a two-dimensional material.

4. The quantum sensor of claim 1, wherein the optical resonator comprises hexagonal boron nitride (hBN).

5. The quantum sensor of claim 1, wherein a thickness of the substrate is 0.1 mm to 1 mm.

6. The quantum sensor of claim 1, wherein the control structure is interposed between the optical resonator and the connection structure.

7. The quantum sensor of claim 1, wherein the control structure has a ring shape in a plan view.

8. The quantum sensor of claim 1, wherein the substrate comprises at least one of polydimethylsiloxane, polyimide, polyethylene terephthalate, polycarbonate, polymethyl methacrylate, polyurethane, or polyethylene naphthalate.

9. The quantum sensor of claim 1, wherein a thickness of the optical resonator is about 100 nm to about 250 nm.

10. The quantum sensor of claim 1, wherein the control structure comprises at least one selected from the group consisting of gold (Au), titanium (Ti), chrome (Cr), platinum (Pt), silver (Ag), and alloys thereof.

11. The quantum sensor of claim 1, wherein a thickness of the control structure is 50 nm to 100 nm.

12. The quantum sensor of claim 1, wherein a diameter of the optical resonator is 5 μm to 10 μm.

13. The quantum sensor of claim 1, wherein the optical resonator comprises hexagonal boron nitride (hBN), and
the point defects are boron vacancies.

14. The quantum sensor of claim 1, wherein the optical resonator has a spin resonance frequency of 2 GHz to 6 GHz.

15. The quantum sensor of claim 1, wherein the optical resonator has a circular shape in a plan view, and
the nanoholes are spaced apart from each other along a circumferential direction of the optical resonator.

16. A method for fabricating a quantum sensor, the method comprising:
forming a substrate;
forming a connection structure on one end of the substrate;
forming a control structure on the substrate;
forming an optical resonator on the substrate so as to be adjacent to the control structure; and
forming, on the one end of the substrate, a connector electrically connected to the connection structure,
wherein the optical resonator comprises a quantum material comprising point defects,
wherein the optical resonator comprises nanoholes arranged in a circular Bragg grating structure.

17. The method of claim 16, wherein the optical resonator has a circular shape in a plan view, and
the nanoholes are spaced apart from each other along a circumferential direction of the optical resonator.

18. The method of claim 16, wherein the optical resonator comprises a two-dimensional material.

19. The method of claim 16, wherein the substrate comprises at least one of polydimethylsiloxane, polyimide, polyethylene terephthalate, polycarbonate, polymethyl methacrylate, polyurethane, or polyethylene naphthalate.

20. The method of claim 16, wherein the forming of the substrate comprises spin coating.
